(19) United States
(12) Patent Application Publication
(10) Pub. No.: US 2014/0368459 A1
(43) Pub. Date: Dec. 18, 2014

(54) TOUCH DEVICE AND SENSING CIRCUIT THEREOF

(71) Applicant: INTEGRATED SOLUTIONS TECHNOLOGY INC., Taipei City (TW)

(72) Inventor: CHIA- CHENG LEI, NEW TAIPEI CITY (TW)

(73) Assignee: INTEGRATED SOLUTIONS TECHNOLOGY INC., Taipei City (TW)

(21) Appl. No.: 14/018,037

(22) Filed: Sep. 4, 2013

(30) Foreign Application Priority Data
Jun. 13, 2013 (TW) 102120885

(51) Int. Cl. G06F 3/044

(52) U.S. Cl. CPC G06F 3/044
USPC 345/174

(57) ABSTRACT

A touch device includes a touch panel and a sensing circuit. The touch panel has vertical electrode-lines and horizontal electrode-lines. The sensing circuit includes a scan signal generator, which sequentially generates a plurality of scan signals to the plurality of horizontal electrode-lines. A plurality of sensing units senses the change in capacitance of the plurality of vertical electrode-lines and outputs a first sensing voltage and a second sensing voltage. A subtractor senses the difference between the first and the second sense voltages to output a horizontal voltage difference or a vertical voltage difference. When one of the sensing unit outputs the first and the second sensing voltages, the subtractor outputs the horizontal voltage difference between the two adjacent horizontal electrode-lines. When two adjacent sensing units output the first and the second sensing voltages, the subtractor output the vertical voltage difference between the two adjacent vertical electrode-lines.

### BACKGROUND

1. Technical Field

The present disclosure relates to a touch device, in particular, to a sensing circuit for a touch panel.

2. Description of Related Art

Many electronic devices today utilize a touch device as their input interfaces, allowing a user to control the electronic device more intuitively and conveniently.

Please refer to FIG. 1A. FIG. 1A is a diagram illustrating a planar view of a mutual-capacitive touch panel. The touch panel 1 comprises a plurality of first electrode-lines G1˜G4 and a plurality of second electrode-lines S1˜S4. The plurality of first electrode-lines G1˜G4 are disposed in intervals in a vertical direction. The plurality of first electrode-lines G1˜G4 expand in a horizontal direction and are parallel to each other. The plurality of second electrode-lines S1˜S4 are disposed in intervals in a horizontal direction. The plurality of second electrode-lines S1˜S4 expand in a vertical direction and are parallel to each other. The plurality of first electrode-lines G1˜G4 and the plurality of second electrode-lines S1˜S4 are electrically insulated to each other. According to the planar view, the first electrode-lines G1˜G4 are interlaced with the plurality of second electrode-lines S1˜S4 to form a plurality of capacitors.

Please refer to FIG. 1B. FIG. 1B is a circuit diagram illustrating an effective circuit of a mutual-capacitive touch panel. In the touch panel 1 shown in FIG. 1A, where the plurality of first electrode-lines G1˜G4 crosses the plurality of second electrode-lines S1˜S4 forms capacitors C₁₁˜Cₘ, C₂₁˜C₂₄, C₃₁˜C₃₄ and C₄₁˜C₄₄. A sensing circuit of the touch panel 1 can sense capacitance variations of the capacitors C₁₁˜C₁₄, C₂₁˜C₂₄, C₃₁˜C₃₄ and C₄₁˜C₄₄, for locating a touch position.

Further, any two adjacent first electrode-lines “G1, G2”, “G2, G3” and “G3, G4” may form non-ideal capacitors C_{G12}, C_{G23} and C_{G34}, and consequently affecting a locating result of the sensing circuit. Similarly, any two adjacent second electrode-lines “S1, S2”, “S2, S3” and “S3, S4” may also form non-ideal capacitors C_{S12}, C_{S23} and C_{S34}, and consequently affecting a locating result of the sensing circuit. In addition, the plurality of first electrode-lines G1˜G4, a plurality of non-ideal capacitors, C_{G1D} (as shown in FIG. 1D), C_{G2D}, C_{G3D}, C_{G4D}, C_{S1D} (as shown in FIG. 1D), C_{S2D}, C_{S3D} and C_{S4D} may exist between the plurality of second electrode-lines S1˜S4 and a common electrode of a display panel of the electronic device, and consequently affecting the locating result of the sensing circuit to the touch device.

Please refer to FIG. 1C. FIG. 1C is a circuit diagram illustrating a conventional touch device. The conventional touch device 2 comprises the touch panel 1 and a driving circuit. The driving circuit comprises a scan signal generator (not illustrated in FIG. 1C) and a sensing circuit. The scan signal generator is coupled to the plurality of first electrode-lines G1˜G4. The sensing circuit comprises a plurality of sensing units. The plurality of sensing units are coupled to the plurality of second electrode-lines S1˜S4 respectively.

The scan signal generator is for generating a plurality of scan signals V_{sig1}˜V_{sig4} and the plurality of scan signals V_{sig1}˜V_{sig4} are transmitted to the plurality of first electrode-lines G1˜G4 respectively. The plurality of scan signals V_{sig1}˜V_{sig4} are pulse signals. Sensing action of the plurality of sensing units are triggered by the rising edges of the plurality of scan signals V_{sig1}˜V_{Sig4}. In a first duration, the scan signal V_{sig1} is transmitted to the first electrode-line G1 and in a second duration, the scan signal V_{sig2} is transmitted to the first electrode-line G2, and so on for the rest of the scan signals V_{sig3} and V_{sig4}. The plurality of sensing units are for sensing signals of the respective coupled second electrode-lines S1˜S4.

By transmitting the plurality of scan signals V_{sig1}˜V_{sig4} to the plurality of first electrode-lines G1˜G4 in different durations as mentioned above, the plurality of sensing units can sense capacitance variations of the respective capacitors C₁₁˜C₁₄ in the first duration, and detect capacitance variations of the respective capacitors C₂₁˜C₂₄ in the second duration, and so on for the other capacitors C₃₁˜C₃₄ and C₄₁˜C₄₄. If a touch position is at where the first electrode-line G3 crosses the second electrode-line S4, a sensing unit coupled to the second electrode-line S4 senses a capacitance variation of the capacitor C₃₄ in a third duration.

The sensing unit comprises a programmable capacitor C_{comp}, a digital-to-analog converter DA (as shown in FIG. 1D), an integration circuit, a switch SW and an analog-to-digital converter AD, where the integration circuit is composed of an operational amplifier OP and an integration capacitor C, and the plurality of sensing units share one analog-to-digital converter AD via a plurality of switches SW. The integration capacitor C is coupled between a negative input terminal and an output terminal of the operational amplifier OP. The output terminal of the operational amplifier OP is coupled to the analog-to-digital converter AD via the switch SW. A positive input terminal of the operational amplifier OP receives a reference voltage V_{ref}. The negative input terminal of the operational amplifier OP is coupled to a corresponding second electrode-line (e.g. S1) and the programmable capacitor C_{comp}. The programmable capacitor C_{comp} is coupled to a compensation voltage V_{comp} and is controlled by the digital-to-analog converter DA for varying the relative capacitance.

Please refer to FIG. 1D. FIG. 1D is a circuit diagram illustrating an effective circuit of a conventional touch device sensing one of the capacitors. When sensing the capacitor C₁₁ in a configuration of the driving circuit mentioned above, effects of other capacitors C_{G1D}, C_{S1D}, C_{G1F} and C_{S1F} also need to be considered, where the capacitors C_{G1F} and C_{S1F} are the capacitor between “a touch object (e.g. a finger) and the first electrode-line G1” and the capacitor between “the touch object and the second electrode-line S1” respectively. The touch object can be effectively seen as a touch object capacitor and a switch SW_{F}. The touch object capacitor and the integration capacitor C can be effectively seen as a capacitor C_{F}. The capacitor C_{F} and the switch SW_{F} are effectively both coupled between the output terminal and the negative input terminal of the operational amplifier OP. A terminal of the capacitors C_{G1D} and C_{S1D} is effectively coupled to one of the two terminals of the capacitor C₁₁ respectively, and the other terminals of the capacitors C_{G1D} and C_{S1D} are effectively coupled to the voltage V_{dis} of the common electrode. The capacitors C_{G1F} and C_{S1F} are effectively coupled in series to each other and the capacitors C_{G1F} and C_{S1F} are effectively coupled between two ends of the capacitor C₁₁.

When the touch object touches where the first electrode-line G1 crosses the second electrode-line S1, the scan signal V_{sig1} is transmitted to the negative input terminal of the operational amplifier OP via a network of the capacitors C₁₁, C_{G1D}, C_{S1D}, C_{G1F} and C_{S1F}. Due to the capacitors C_{G1D} and C_{S1D}, the digital-to-analog converter DA outputs an analog signal to change a capacitance of the programmable capacitor C_{comp}, and the compensation voltage is transmitted to the negative input terminal of the operational amplifier OP via the programmable capacitor C_{comp}, for compensating how the capacitors C_{G1D} and C_{S1D} affect the output signal Vₒᵤₜ.

Since every touch panel is affected by process variation, the capacitors C_{G1D}˜C_{G4D} and C_{S1D}˜C_{S4D} are not identical to each other. Before each touch device is shipped out of factory, the touch device manufacturer needs to identify capacitances of the plurality of programmable capacitors C_{comp}, for offsetting the effects of the non-ideal capacitors C_{G1D}˜C_{G4D} and C_{S1D}˜C_{S4D} respectively, and the capacitances are to be recorded. In other words, each touch device requires a storage device to record the plurality of capacitances and each touch device also requires a plurality of digital-to-analog convertors. Hence, the higher the resolution of the touch panel, the higher the cost of the touch device. Further, since the capacitances of the plurality of programmable capacitors need to be identified for each touch device before being shipped out of factory as mentioned above, cost and time for manufacturing the touch device are also increased.

### SUMMARY

An exemplary embodiment of the present disclosure provides a touch device. The touch device comprises a touch panel and a sensing circuit. The touch panel comprises a plurality of horizontal electrode-lines and a plurality of vertical electrode-lines crossing each other. The plurality of horizontal electrode-lines and the plurality of vertical electrode-lines are electrically insulated to each other. The sensing circuit comprises a scan signal generator, a plurality of sensing units and a subtractor. The scan signal generator is for generating a plurality of scan signals to the plurality of horizontal electrode-lines in a predetermined duration. The plurality of sensing units is coupled to the plurality of vertical electrode-lines respectively, for sensing a capacitance variation of the plurality of vertical electrode-lines, so as to output a first sensing voltage and a second sensing voltage. The subtractor is coupled to the plurality of sensing units, for sensing a difference between the first sensing voltage and the second sensing voltage, so as to output a horizontal voltage difference or a vertical voltage difference respectively. The first sensing voltage and the second sensing voltage are outputted by one of the plurality of sensing units or by two adjacent sensing units. When the first sensing voltage and the second sensing voltage are outputted by one of the plurality of sensing units, the subtractor outputs the horizontal voltage difference corresponding to the two adjacent horizontal electrode-lines. When the first sensing voltage and the second sensing voltage are outputted by the two adjacent sensing units respectively, the subtractor outputs the vertical voltage difference corresponding to two adjacent vertical electrode-lines.

An exemplary embodiment of the present disclosure further provides a sensing circuit, for sensing a touch panel. The touch panel comprises a plurality of horizontal electrode-lines and a plurality of vertical electrode-lines crossing each other, wherein the plurality horizontal electrode-lines and the plurality of vertical electrode-lines are electrically insulated to each other. The sensing circuit comprises a scan signal generator, a plurality of sensing units and a subtractor. The scan signal generator is for generating a plurality of scan signals to the plurality of horizontal electrode-lines in a predetermined duration. The plurality of sensing units is coupled to plurality of vertical electrode-lines respectively, for sensing a capacitance variation of the plurality of vertical electrode-lines, so as to output a first sensing voltage and a second sensing voltage. The subtractor is coupled to the plurality of sensing units, for sensing a difference between the first sensing voltage and the second sensing voltage, so as to output a horizontal voltage difference or a vertical voltage difference respectively. The first sensing voltage and the second sensing voltage are outputted by one of the plurality of sensing units or by two adjacent sensing units. When the first sensing voltage and the second sensing voltage are outputted by one of the plurality of sensing units, the subtractor outputs the horizontal voltage difference corresponding to the two adjacent horizontal electrode-lines. When the first sensing voltage and the second sensing voltage are outputted by the two adjacent sensing units respectively, the subtractor outputs the vertical voltage difference corresponding to two adjacent vertical electrode-lines.

In summary, the sensing circuit of the touch device and the touch panel thereof of the embodiment of the present disclosure can determine whether the touch panel has been touched and the relative touch position, according to the horizontal voltage difference between the first sensing voltage and the second sensing voltage outputted by one of the plurality of sensing units calculated by the subtractor or the vertical voltage difference between the first sensing voltage and the second sensing voltage outputted by two adjacent sensing units calculated by the subtractor.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a diagram illustrating a planar view of a mutual-capacitive touch panel.

FIG. 1B is a circuit diagram illustrating an effective circuit of a mutual-capacitive touch panel.

FIG. 1C is a circuit diagram illustrating a conventional touch device.

FIG. 1D is a circuit diagram illustrating an effective circuit of a conventional touch device sensing one of the capacitors.

FIG. 2A is a circuit diagram illustrating a touch device according to an embodiment of the present disclosure.

FIG. 2B is a circuit diagram illustrating sensing units according to an embodiment of the present disclosure.

FIG. 3 is a timing diagram of the touch device according to an embodiment of the present disclosure.

FIG. 4 is a timing diagram of the touch device according to another embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### An Embodiment of a Touch Device

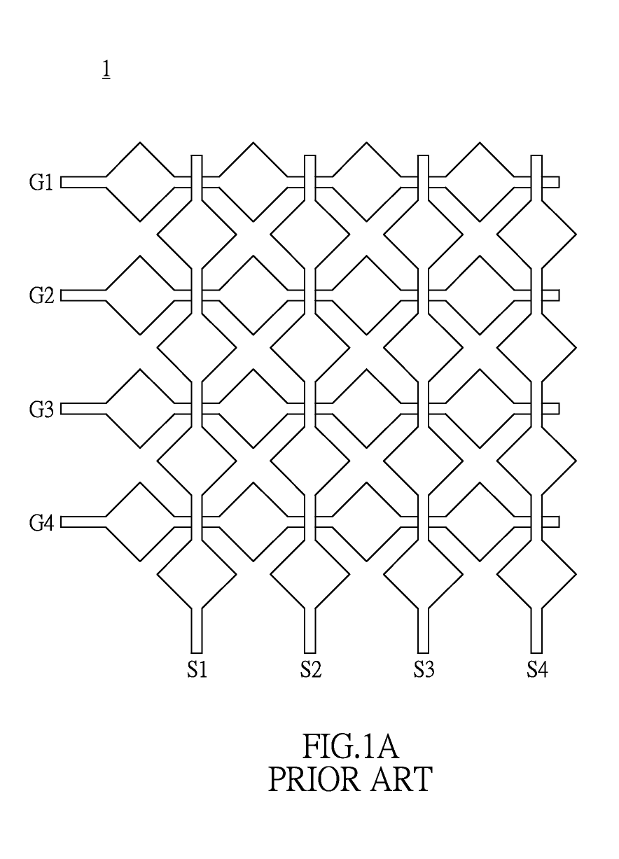

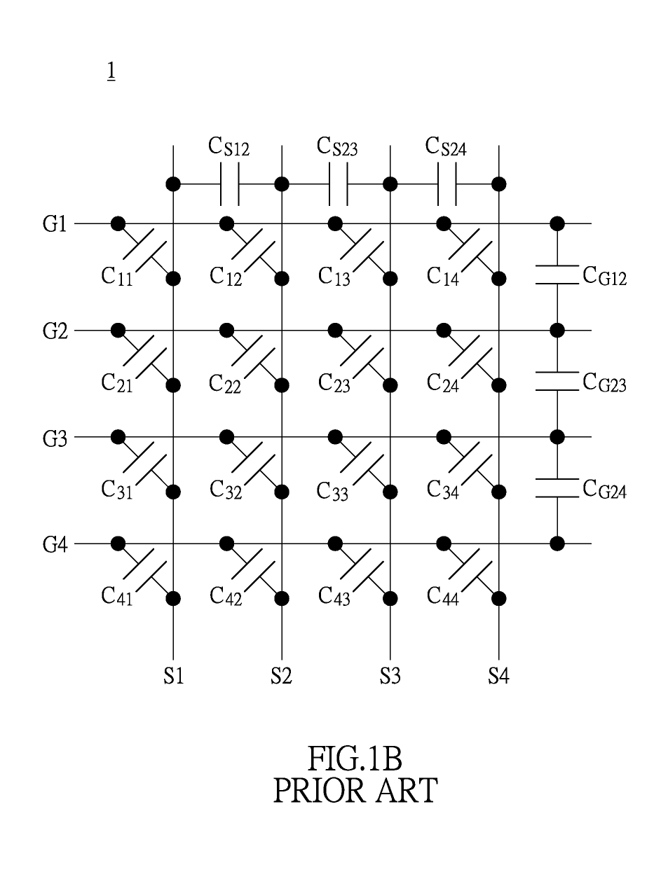

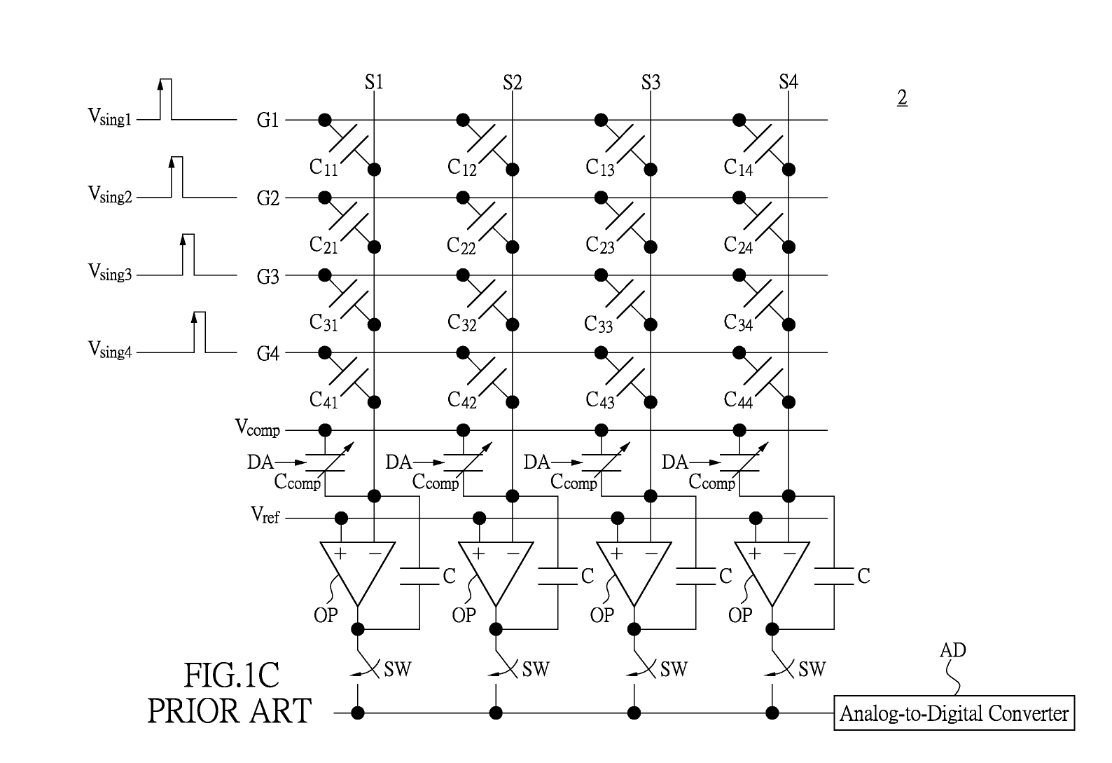

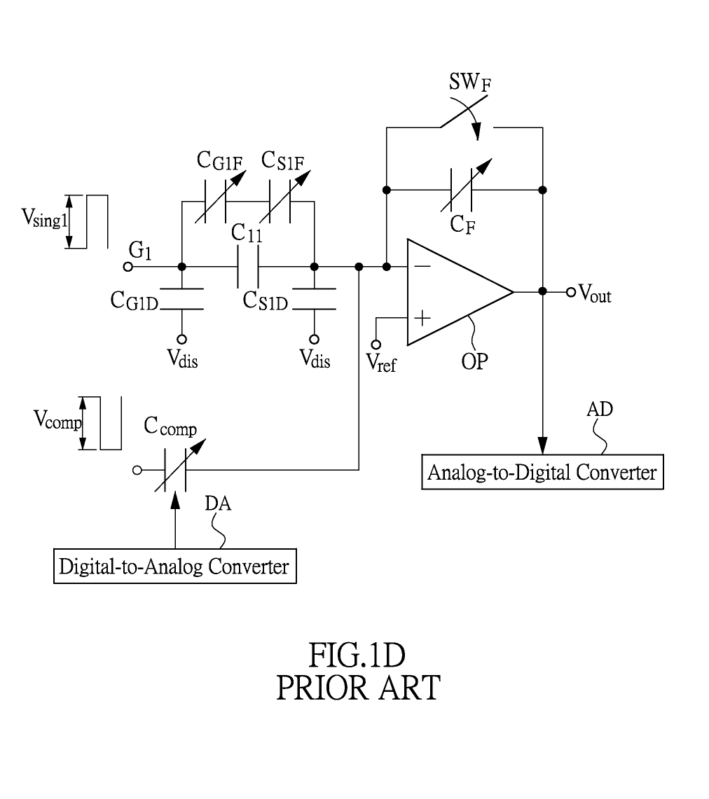

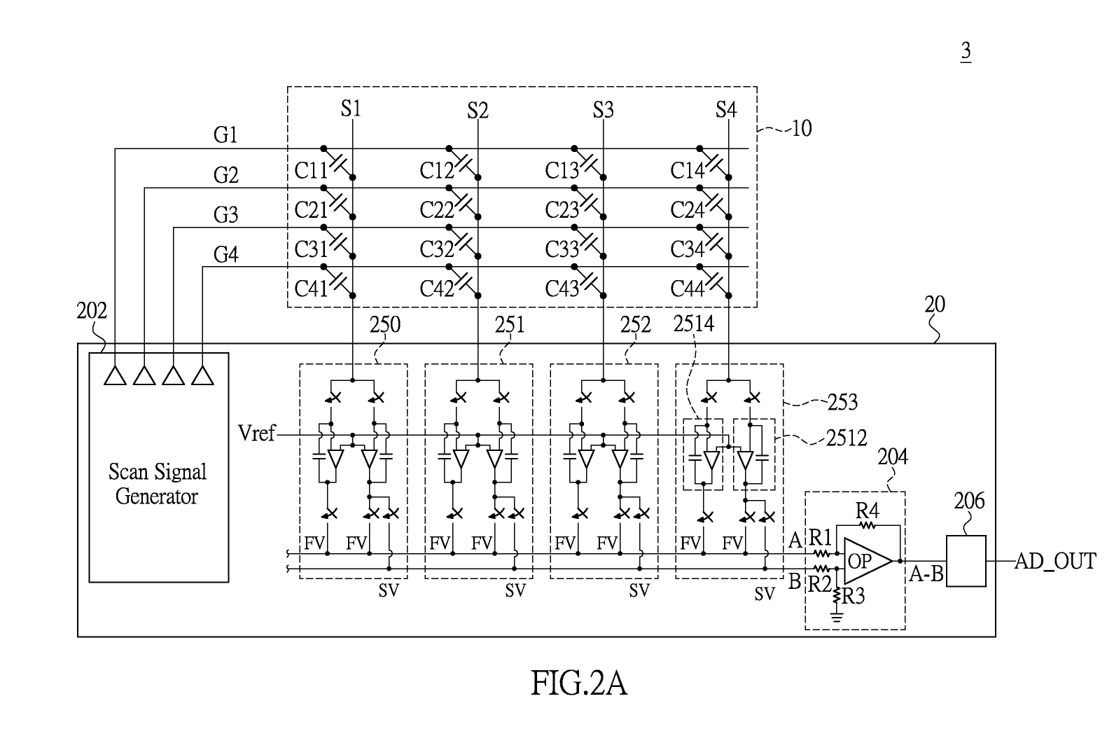

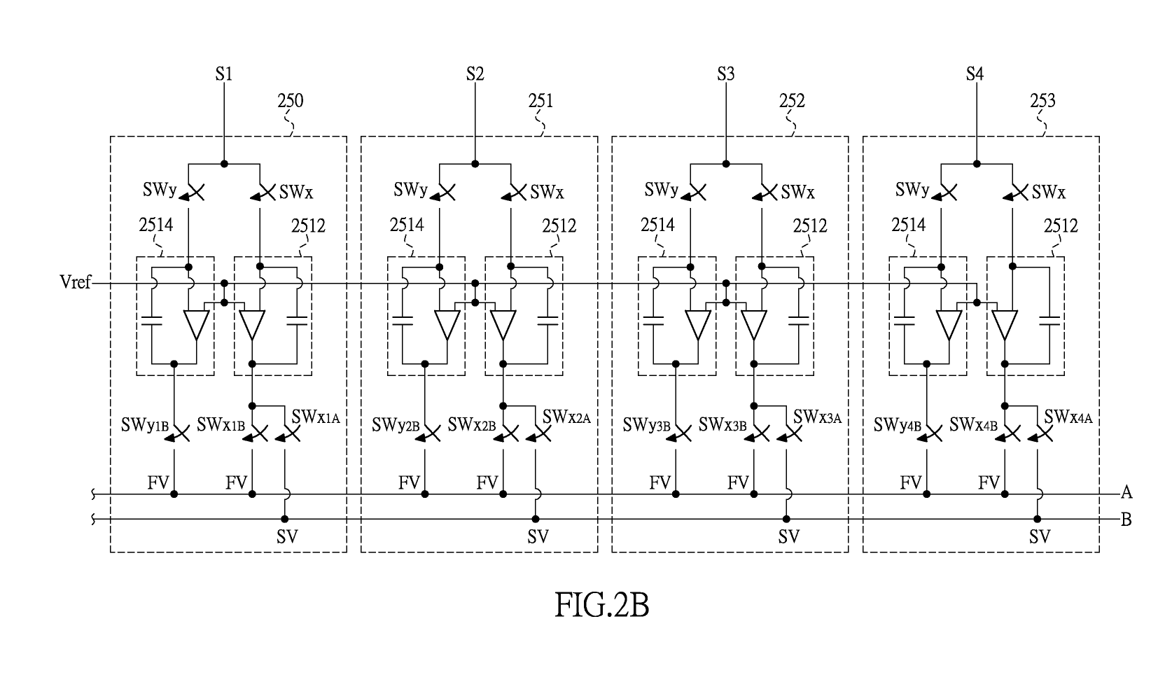

Please refer to FIG. 2A and FIG. 2B. FIG. 2A is a circuit diagram illustrating a touch device according to an embodiment of the present disclosure. FIG. 2B is a circuit diagram illustrating sensing units according to an embodiment of the present disclosure. A touch device 3 comprises a touch panel 10 and a sensing circuit 20, where the touch panel 10 is similar to the touch panel 1 in FIG. 1A. The sensing circuit 20 comprises a scan signal generator 202, a plurality of sensing units 250˜253, a subtractor 204 and an analog-to-digital converter 206. The scan signal generator 202 is coupled to a plurality of horizontal electrode-lines G1˜G4, and generates a plurality of scan signals to the plurality of horizontal electrode-lines G1˜G4 sequentially in a plurality of predetermined durations. The plurality of sensing units 250˜253 are coupled to the a plurality of vertical electrode-lines S1˜S4 respectively, for sensing capacitance variations of capacitors C11˜C44 (located at where the plurality of vertical electrode-lines S1˜S4 crosses the plurality of horizontal electrode-lines G1˜G4 respectively), so as to output a first sensing voltage FV and a second sensing voltage SV. The subtractor 204 comprises a first input terminal A and a second input terminal B, each coupled to the plurality of sensing units 250˜253, for sensing a difference between the first sensing voltage FV and the second sensing voltage SV, so as to output a horizontal voltage difference or a vertical voltage difference via the output terminal of the subtractor. In the present embodiment, a voltage signal outputted by the sensing circuit 20 to the first input terminal A of the subtractor 204 is called the first sensing voltage FV, and a voltage signal outputted by the sensing circuit 20 to the second input terminal B of the subtractor 204 is called the second sensing voltage SV.

The subtractor 204 comprises an operational amplifier OP, a first resistor R1, a second resistor R2, a third resistor R3 and a fourth resistor R4. The first resistor R1 is coupled between the plurality of sensing units 250˜253 and a first input terminal of the operational amplifier OP. The second resistor R2 is coupled between the plurality of sensing units 250˜253 and a second input terminal of the operational amplifier OP. The third resistor R3 is coupled between the second input terminal of the operational amplifier OP and a grounding terminal GND. The fourth resistor R4 is coupled between the first input terminal of the operational amplifier OP and an output terminal of the operational amplifier OP.

In the present embodiment, the scan signal generator 202 can generate scan signals sequentially to the horizontal electrode-lines G1˜G4, for the sensing units 250˜253 which are coupled to the vertical electrode-lines 250˜253 to perform sensing. Each of the sensing units 250˜253 possesses two sets of integrators 2512 and 2514 and switches (as shown in FIG. 2A) which are for switching circuit paths, so electric charge variations of the horizontal electrode-lines G1˜G4 can be sensed according to a timing of the scan signals. One sensing unit (e.g. the sensing unit 250) can sense a horizontal voltage difference between two adjacent horizontal electrode-lines (e.g. G1 and G2). Adjacent sensing units (e.g. 250 and 251) can sense a vertical voltage difference between the adjacent vertical electrode-lines (e.g. S1 and S2). The horizontal voltage difference can be utilized to represent a capacitance variation between two capacitors (e.g. C11 and C21) on two horizontal electrode-lines. The vertical voltage difference can be utilized to represent a capacitance variation between two capacitors (e.g. C11 and C12) on two vertical electrode-lines.

For instance, when the scan signal generator 202 outputs a scan signal to the horizontal electrode-lines G1 and G2, the sensing unit 250 can output a second sensing voltage SV (the third switch SW_{X1A} is turned on) corresponding to the horizontal electrode-line G1 and a first sensing voltage FV (the fifth switch SW_{y1B} is turned on). A voltage difference between the first sensing voltage FV and the second sensing voltage SV can be utilized to represent a capacitance variation between the capacitor C11 and the capacitor C21. The second sensing voltage SV outputted by the sensing unit 250 can be compared to the first sensing voltage FV (the fourth switch SW_{X2B} is turned on) outputted by the sensing unit 251, for generating a vertical voltage difference. The vertical voltage difference can represent a capacitance variation between the capacitor C11 and the capacitor C12. Similarly, other sensing units 250˜253 can be utilized to sense capacitance variations of other locations of the touch panel 10. Based on the capacitance variances of the adjacent capacitors, a backend calculating circuit (not illustrated) can then determine a touch position or a touch gesture of a user according to array data of the capacitance variations.

Further, the first sensing voltage FV and the second sensing voltage SV can be outputted by one of the plurality of sensing units 250˜253, or by two adjacent sensing units (e.g. sensing units 250 and 251) of the sensing units 250˜253. Hence, when the first sensing voltage FV and the second sensing voltage SV are outputted by one of the plurality of sensing units 250˜253, the subtractor 204 outputs a horizontal voltage difference corresponding to two adjacent horizontal electrode-lines (e.g. horizontal electrode-lines G1 and G2) of the horizontal electrode-lines G1˜G4. When the first sensing voltage FV and the second sensing voltage SV are outputted by two adjacent sensing units (e.g. sensing units 250 and 251) respectively of the sensing units 250˜253, the subtractor 204 outputs a vertical voltage difference corresponding to two adjacent vertical electrode-lines (e.g. vertical electrode-lines S1 and S2) of the vertical electrode-lines S1˜S4. The analog-to-digital convertor 206 is coupled to an output terminal of the subtractor 204, for converting the horizontal voltage difference and the vertical voltage difference outputted by the subtractor 204 to a digital signal. The digital signal is utilized to determine a user's touch position accordingly.

The present embodiment does not limit the number of horizontal electrode-lines G1˜G4 or the number of vertical electrode-lines S1˜S4. Those skilled in the art can design differently according to practical needs. Further, a plurality of capacitors can be formed between the plurality of horizontal electrode-lines G1˜G4 and the plurality of vertical electrode-lines S1˜S4. For instance, the capacitor C11 can be formed between the horizontal electrode-line G1 and the vertical electrode-line S1.

In the present embodiment, the scan signal generator 202 generating a first scan signal and a second scan signal in three durations sequentially is further explained. The scan signal generator 202 can also sequentially generate the first scan signal and the second scan signal in a plurality of durations and the present embodiment is not limited thereto. Those skilled in the art can design differently according to practical needs.

More specifically, the scan signal generator 202 periodically supplies a plurality of scan signals and transmits the plurality of scan signals to the plurality of horizontal electrode-lines G1˜G4. The scan signal generator 202 generates the first scan signal and the second scan signal in three durations, so a time difference exists between the first scan signal and the second scan signal. For instance, in the first duration, the first scan signal and the second scan signal are generated and transmitted to the to-be-scanned horizontal electrode-line G1 and another horizontal electrode-line G2. In the second duration, the first scan signal and the second scan signal are generated and transmitted to the to-be-scanned horizontal electrode-line G2 and another horizontal electrode-line G3. Subsequently, in the third duration, the first scan signal and the second scan signal are generated and transmitted to the to-be-scanned horizontal electrode-line G3 and another horizontal electrode-line G4. In other embodiments, the scan signal generator 202 can also generate and transmit the first scan signal and the second scan signal, in the first duration, to the to-be-scanned horizontal electrode-line G2 and another horizontal electrode-line G3. The present embodiment does not limit the sequence of the scan signal generator 202 scans the horizontal electrode-lines G1˜G4. The scanning sequence can be designed according to practical needs.

Please refer to FIG. 2A and FIG. 2B together. In the present embodiment, the sensing circuit comprises four sensing units 250˜253. In other embodiments however, the sensing circuit can comprise more than four sensing units 250˜253. Those skilled in the art can design differently according to practical needs. As shown in FIG. 2B, internal circuitries of the four sensing units 250˜253 are designed similarly.

More specifically, each of the sensing units 250˜253 comprises a first integrator 2512, a second integrator 2514, a first switch SW_{X}, a second switch SW_{y}, a third switch SW_{X1A}˜SW_{X4A}, a fourth switch SW_{X1B}˜SW_{X4B} and a fifth switch SW_{y1B}˜SW_{y4B}. The first switch SW_{X} is coupled between a corresponding one of the plurality of vertical electrode-lines S1˜S4 and an input of the first integrator 2512. The second switch SW_{y} is coupled between a corresponding one of the plurality of vertical electrode-lines S1˜S4 and an input of the second integrator 2514. The third switch SW_{X1A}˜SW_{X4A} is coupled between an output of the first integrator 2512 and the second input terminal B of the subtractor 204. The fourth switch SW_{X1B}˜SW_{X4B} is coupled between the output of the first integrator 2512 and the first input terminal A of the subtractor 204. The fifth switch SW_{y1B}˜SW_{y4B} is coupled between an output of the second integrator 2514 and the first input terminal A of the subtractor 204. Further, the analog-to-digital convertor 206 is coupled to the output terminal of the subtractor 204, for converting the vertical voltage difference and the horizontal voltage difference outputted by the subtractor 204 from an analog signal to a digital signal, so as to determine an occurrence of touch action according to the converted digital signal. The first switch SW_{X} and the second switch SW_{y} are turned on alternately according to the timing of the plurality of scan signals, for the first integrator 2512 and the second integrator 2514 to perform integration to voltages of two adjacent vertical electrode-lines of the vertical electrode-lines S1˜S4 respectively.

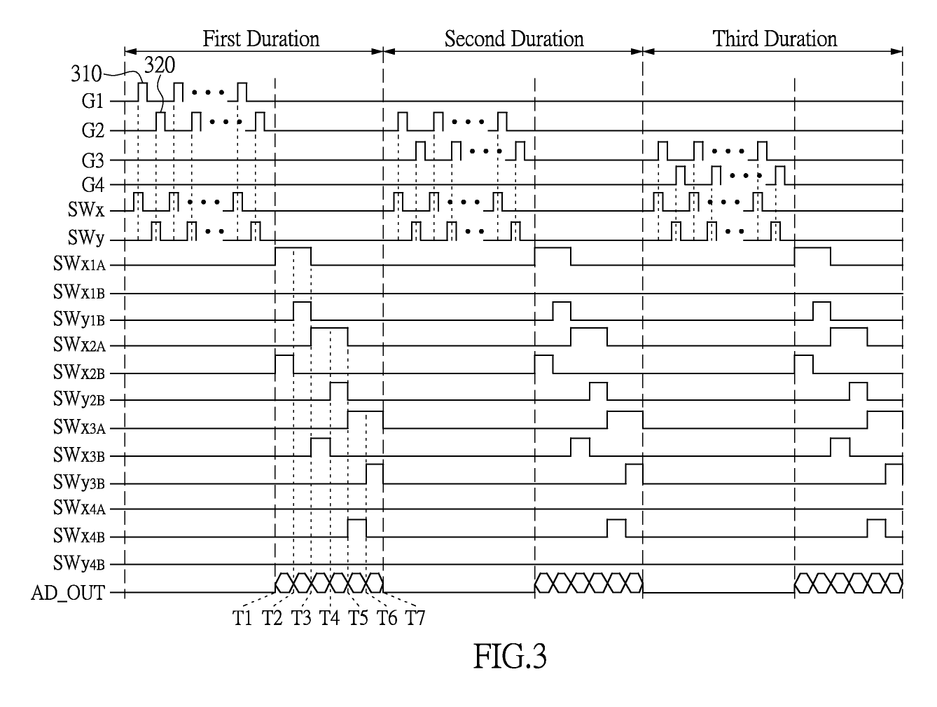

The operation principle of the touch device of the present embodiment is further explained below. Please refer to FIG. 2A, FIG. 2B and FIG. 3 together. FIG. 3 is a timing diagram of the touch device according to the present embodiment. In the present embodiment, in a first duration, the scan signal generator 202 generates a first scan signal to a to-be-scanned horizontal electrode-line G1, and generates a second scan signal to another horizontal electrode-line G2, where a timing difference exists between the first horizontal scan signal and the second scan signal. In other words, the scan signal generator 202 firstly generates the first scan signal to the horizontal electrode-line G1 and then generates the second scan signal to another horizontal electrode-line G2.

Taking the horizontal electrode-lines G1 and G2 performing sensing as an example, the scan signal can be consisted of pulse signals. The scan signal generator 202 outputs pulse signals 310 and 320 alternately to the horizontal electrode-lines G1 and G2. In the present embodiment, the timing corresponding to each switch to be turned on is shown in FIG. 3. A switch is turned on and turned off when the corresponding signal is logic high and logic low respectively. In another embodiment, however, the relation between the corresponding signal and whether the switch is turned on or off can be completely opposite to the above mentioned description and is not limited by the present disclosure. The first switch SW_{X} of the sensing unit 250 can be turned on according to a timing of the pulse signal 310 and the second switch SW_{y} can be turned on according to a timing of the pulse signal 320, for the first integrator 2512 to sense the capacitor C11 which is between the horizontal electrode-line G1 and the vertical electrode-line S1, and for the second integrator 2514 to sense the capacitor C21 which is between the horizontal electrode-line G2 and the vertical electrode-line S1, respectively. Similarly, the first switch SW_{X} of the sensing unit 251 can be turned on according to a timing of the pulse signal 310 and the second switch SW_{y} can be turned on according to a timing of the pulse signal 320, for the first integrator 2512 to sense the capacitor C12 which is between the horizontal electrode-line G1 and the vertical electrode-line S2, and for the second integrator 2514 to sense the capacitor C22 which is between the horizontal electrode-line G2 and the vertical electrode-line S2, respectively.

Therefore, sensed values of the capacitor C11 and the capacitor C21 are stored in the first integrator 2512 and the second integrator 2514 in the sensing unit 250 respectively. Hence the subtractor 204 can output a horizontal voltage difference (between the durations T2 and T3) corresponding to the capacitance variation between the capacitor C11 and the capacitor C21, according to the first sensing voltage FV (the fifth switch SW_{y1B} is turned on) and the second sensing voltage SV (the third switch SW_{X1A} is turned on) outputted by the sensing unit 250. Similarly, sensed values of the capacitor C11 and the capacitor C12 are stored in the first integrator 2512 of the sensing unit 250 and the first integrator 2512 of the sensing unit 251 respectively. Hence the subtractor 204 can output a vertical voltage difference (between the durations T1 and T2) corresponding to the capacitance variation between the capacitor C11 and the capacitor C12, according to the second sensing voltage SV (the third switch SW_{X1A} is turned on) outputted by the first integrator 2512 of the sensing unit 250, and the first sensing voltage FV (the fourth switch SW_{X2B} is turned on) outputted by the first integrator 2512 of the sensing unit 251. Other methods for sensing capacitance variations and the relative timing for switches to be turned on/off are shown in FIG. 3. The sensing circuit 20 can complete sensing procedures of the horizontal electrode-lines G1 and G2 in the first duration according to signal sequences in instances T1˜T7. The sensing circuit 20 can then drive the vertical electrode-lines S2 and S3 and complete sensing procedures of the horizontal electrode-lines G2 and G3 in the second duration according to signal sequences shown in FIG. 3. Similarly the sensing circuit 20 can complete sensing procedures of the horizontal electrode-lines G3 and G4 in the third duration according to signal sequences shown in FIG. 3.

Sequences for the third switches SW_{X1A}˜SW_{X4A}, the fourth switches SW_{X1B}˜SW_{X4B}, the first switch SW_{X} and the second switch SW_{y} to be turned on are according to an order of the capacitors being sensed and a timing of the scan signal. FIG. 3 is merely an exemplary embodiment of the present disclosure. The present disclosure does not limit the above-mentioned scan timing and the sequence of the switches being turned on.

The subtractor 204 performs subtraction calculation according to the first sensing voltage FV and the second sensing voltage SV received by the first input terminal A and the second input terminal B respectively, for accordingly outputting the horizontal voltage difference and the vertical voltage difference to the analog-to-digital convertor 206. The analog-to-digital convertor 206 can convert the horizontal voltage difference and the vertical voltage difference into a digital signal AD_OUT (e.g. a binary digital signal), for a backend determining circuit (not illustrated) to determine whether the touch panel 10 has been touched and the relative touch position.

### Another Embodiment of the Touch Device

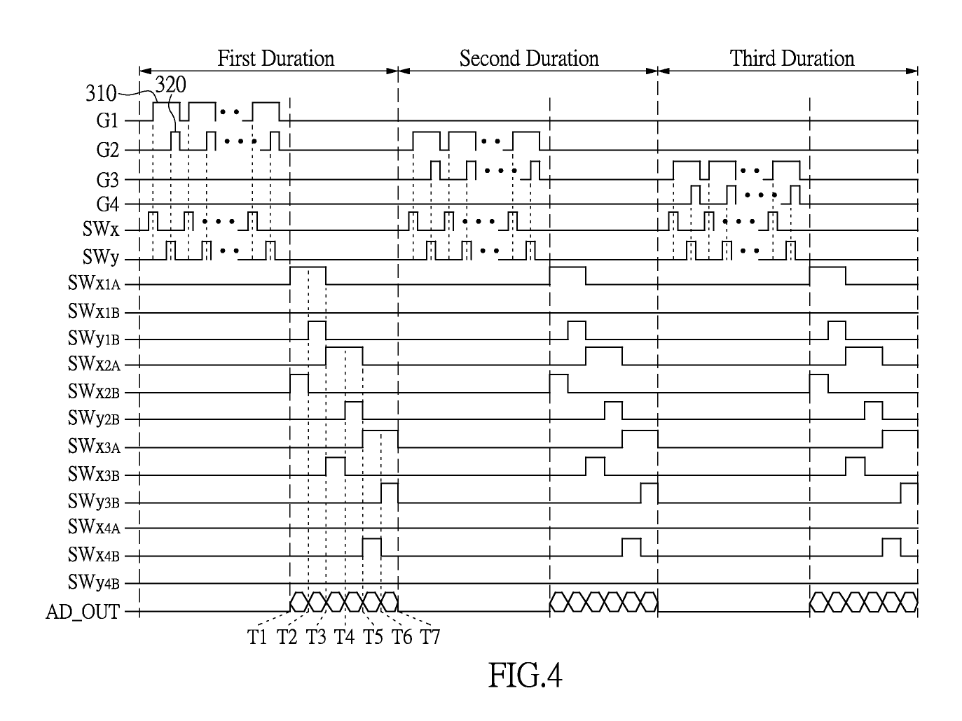

Please refer to FIG. 4. FIG. 4 is a timing diagram of the touch device according to another embodiment of the present disclosure. In the present embodiment, the structure of the touch device is similar to that of the touch device 3 in FIG. 2A, where the same components are labeled with the same notation. A difference between the touch device in FIG. 2A and the present disclosure is the timing difference between the scan signal generator 202 generates the first scan signal and the second scan signal.

More specifically, please refer to FIG. 3 and FIG. 4 together. As shown in FIG. 3, in the first duration, the scan signal generator 202 generates a first scan signal and a second scan signal to the to-be-scanned horizontal electrode-lines G1 and G2 respectively. The first scan signal and the second scan signal are transmitted to the respective to-be-scanned horizontal electrode-lines G1 and G2 alternately. In other words, when the scan signal generator 202 generates the first scan signal to the to-be-scanned horizontal electrode-line G1, the scan signal generator 202 does not generate the second scan signal to the to-be-scanned horizontal electrode-line G2. Instead, the scan signal generator 202 generates the second scan signal to the to-be-scanned horizontal electrode-line G2 after the scan signal generator 202 has stopped generating the first scan signal to the to-be-scanned horizontal electrode-line G1.

Please refer to FIG. 4. In the present embodiment, the first scan signal and the second scan signal are not transmitted to the respective to-be-scanned horizontal electrode-lines G1 and G2 alternately. Instead, the first scan signal is supplied to the to-be-scanned horizontal electrode-line G1 continuously, and the scan signal generator 202 generates the second scan signal to the to-be-scanned horizontal electrode-line G2 in the same duration. Afterwards the scan signal generator 202 stops generating the first scan signal and the second scan signal altogether, and then the scan signal generator 202 starts generating the first scan signal to the to-be-scanned horizontal electrode-line G1 again.

Simply put, in the present embodiment, the scan signal generator 202 generates the first scan signal to the to-be-scanned horizontal electrode-line G1 for a certain period, then generates the second scan signal to the to-be-scanned horizontal electrode-line G2 and then stops altogether. In other words, the duration of the scan signal generator 202 generating the first scan signal to the to-be-scanned horizontal electrode-line G1 is longer than the duration of the scan signal generator 202 generating the second scan signal to the to-be-scanned horizontal electrode-line G2. Therefore by utilizing the method of providing the first scan signal and the second scan signal of the present embodiment, signals of adjacent horizontal electrode-lines G1 and G2 can be even closer to each other, hence decreasing the noise and the possibility of misjudgment.

Apart from above-mentioned differences, it should be obvious to those skilled in the art that the operation of the present embodiment is effectively equivalent to that of the touch device 3 in FIG. 2A. Those skilled in the art could also easily extrapolate the operation of the present embodiment is effectively equivalent to that of the touch device 3 in FIG. 2A, according to the touch device 3 shown in FIG. 2A and the above-mentioned differences. The relative descriptions are therefore omitted hereinafter.

The sensing circuit 20 of the above embodiment can directly output a capacitance difference between two adjacent capacitors to the backend circuit for decision making. The backend circuit can directly obtain the capacitance variation between adjacent capacitors without requiring additional calculation, so the calculation requirement of the backend circuit is simplified and the sensing speed can be increased. In other words, the present disclosure utilizes hardware circuit to realize certain functions of software calculation, for simplifying the calculation requirement of a conventional touch sensing panel and effectively increasing the system efficiency.

### Possible Effects of the Embodiments

In summary, the sensing circuit of the touch device and the touch panel thereof of the embodiment of the present disclosure can determine whether the touch panel has been touched and the relative touch position, according to the horizontal voltage difference between the first sensing voltage and the second sensing voltage outputted by one of the plurality of sensing units calculated by the subtractor or the vertical voltage difference between the first sensing voltage and the second sensing voltage outputted by two adjacent sensing units calculated by the subtractor.

Further, the sensing circuit of the touch device and the touch panel thereof of the embodiment of the present disclosure can calculate, via hardware, the horizontal voltage and the horizontal voltage difference outputted according to the capacitance variation between a horizontal electrode-line and another comparing horizontal electrode-line, each corresponding to relative crossed vertical electrode-line. Hence loading of the backend circuit can be decreased.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A touch device, comprising:
a touch panel, comprising a plurality of horizontal electrode-lines and a plurality of vertical electrode-lines crossing each other, wherein the plurality of horizontal electrode-lines and the plurality of vertical electrode-lines are electrically insulated to each other; and
a sensing circuit, the sensing circuit comprising:
a scan signal generator, for generating a plurality of scan signals to the plurality of horizontal electrode-lines in a predetermined duration;
a plurality of sensing units, coupled to plurality of vertical electrode-lines respectively, for sensing a capacitance variation of the plurality of vertical electrode-lines, so as to output a first sensing voltage and a second sensing voltage; and
a subtractor, coupled to the plurality of sensing units, for sensing a difference between the first sensing voltage and the second sensing voltage, so as to output a horizontal voltage difference or a vertical voltage difference respectively;
wherein the first sensing voltage and the second sensing voltage are outputted by one of the plurality of sensing units or by two adjacent sensing units, when the first sensing voltage and the second sensing voltage are outputted by one of the plurality of sensing units, the subtractor outputs the horizontal voltage difference corresponding to the two adjacent horizontal electrode-lines, when the first sensing voltage and the second sensing voltage are outputted by the two adjacent sensing units respectively, the subtractor outputs the vertical voltage difference corresponding to two adjacent vertical electrode-lines.

2. The touch device according to claim 1, wherein each of the plurality of sensing units comprises:
a first integrator;
a second integrator;
a first switch, coupled between a corresponding one of the plurality of vertical electrode-lines and an input of the first integrator;
a second switch, coupled between a corresponding one of the plurality of vertical electrode-lines and an input of the second integrator;
a third switch, coupled between an output of the first integrator and a second input terminal of the subtractor;
a fourth switch, coupled between the output of the first integrator and a first input terminal of the subtractor; and
a fifth switch, coupled between an output of the second integrator and the first input terminal of the subtractor;
wherein the first switch and the second switch are turned on alternately corresponding to a timing of the plurality of scan signals, for the first integrator and the second integrator to perform integration to voltages of two adjacent horizontal electrode-lines respectively.

3. The touch device according to claim 2, wherein when the first sensing voltage and the second sensing voltage are outputted by the first integrator and the second integrator respectively of one of the plurality of sensing units, the third switch and the fifth switch are turned on, when the first sensing voltage and the second sensing voltage are outputted by a first sensing unit and an adjacent second sensing unit respectively, the fourth switch of the first sensing unit is turned on and the third switch of the second sensing unit is turn on.

4. The touch device according to claim 2, wherein the subtractor comprises:
an operational amplifier;
a first resistor, coupled between the plurality of sensing units and a first input terminal of the operational amplifier;
a second resistor, coupled between the plurality of sensing units and a second input terminal of the operational amplifier;
a third resistor, coupled between the second input terminal of the operational amplifier and a grounding terminal; and
a fourth resistor, coupled between the first input terminal of the operational amplifier and an output terminal of the operational amplifier.

5. The touch device according to claim 2, wherein the sensing circuit further comprises an analog-to-digital convertor, coupled to an output terminal of the subtractor.

6. A sensing circuit, for sensing a touch panel, the touch panel comprising a plurality of horizontal electrode-lines and a plurality of vertical electrode-lines crossing each other, wherein the plurality horizontal electrode-lines and the plurality of vertical electrode-lines are electrically insulated to each other, the sensing circuit comprising:
a scan signal generator, for generating a plurality of scan signals to the plurality of horizontal electrode-lines in a predetermined duration;
a plurality of sensing units, coupled to plurality of vertical electrode-lines respectively, for sensing a capacitance variation of the plurality of vertical electrode-lines, so as to output a first sensing voltage and a second sensing voltage; and
a subtractor, coupled to the plurality of sensing units, for sensing a difference between the first sensing voltage and the second sensing voltage, so as to output a horizontal voltage difference or a vertical voltage difference respectively;
wherein the first sensing voltage and the second sensing voltage are outputted by one of the plurality of sensing units or by two adjacent sensing units, when the first sensing voltage and the second sensing voltage are outputted by one of the plurality of sensing units, the subtractor outputs the horizontal voltage difference corresponding to the two adjacent horizontal electrode-lines, when the first sensing voltage and the second sensing voltage are outputted by the two adjacent sensing units respectively, the subtractor outputs the vertical voltage difference corresponding to two adjacent vertical electrode-lines.

7. The sensing circuit according to claim 6, wherein the sensing unit comprises:
a first integrator;
a second integrator;
a first switch, coupled between a corresponding one of the plurality of vertical electrode-lines and an input of the first integrator;
a second switch, coupled between a corresponding one of the plurality of vertical electrode-lines and an input of the first integrator;
a third switch, coupled between an output of the first integrator and a first input terminal of the subtractor;
a fourth switch, coupled between the an output of the second integrator and a first input terminal of the subtractor; and
a fifth switch, coupled between an output of the second integrator and a second input terminal of the subtractor;
wherein the first switch and the second switch are turned on alternately corresponding to a timing of the plurality of scan signals, for the first integrator and the second integrator to perform integration to voltages of two adjacent horizontal electrode-lines respectively.

8. The sensing circuit according to claim 7, wherein when the first sensing voltage and the second sensing voltage are outputted respectively by the first integrator and the second integrator of one of the plurality of sensing units, the third switch and the fifth switch are turned on, when the first sensing voltage and the second sensing voltage are outputted respectively by a first sensing unit and an adjacent second sensing unit, the fourth switch of the first sensing unit is turned on and the third switch of the second unit is turn on.

9. The sensing circuit according to claim 7, wherein the subtractor comprises:
an operational amplifier;
a first resistor, coupled between the plurality of sensing units and a first input terminal of the operational amplifier;
a second resistor, coupled between the plurality of sensing units and a second input terminal of the operational amplifier;
a third resistor, coupled between the second input terminal of the operational amplifier and a grounding terminal; and
a fourth resistor, coupled between the first input terminal of the operational amplifier and an output terminal of the operational amplifier.

10. The sensing circuit according to claim 7, wherein the sensing circuit further comprises an analog-to-digital convertor, coupled to an output terminal of the subtractor.
